(19) United States
(12) Patent Application Publication
(10) Pub. No.: US 2024/0205521 A1
(43) Pub. Date: Jun. 20, 2024

(54) ACTION MIRRORING IN ONLINE MEETINGS

(71) Applicant: International Business Machines Corporation, Armonk, NY (US)

(72) Inventors: Yi Jie Ma, Beijing (CN); Jing Wen Chen, BEIJING (CN); Jing Ren, Beijing (CN); Zhao Yu Wang, BEIJING (CN); Xizhuo Zhang, Beijing (CN)

(21) Appl. No.: 18/065,661

(22) Filed: Dec. 14, 2022

(51) Int. Cl. H04N 21/858

(52) U.S. Cl. CPC H04N 21/858

(57) ABSTRACT

A method, computer program product and computer system are provided to minimize data transfer in an online meeting. A processor initiates an online meeting between at least one broadcaster and at least one viewer. A processor captures actions performed by the at least one broadcaster during the online meeting. A processor converts at least one action performed by the broadcaster to a uniform resource identifier (URI). A processor sends the captured actions including the URI to the at least one viewer, where the captured actions including the URI replicate locally the at least one broadcaster's captured actions on a device associated with the viewer.

### BACKGROUND OF THE INVENTION

The present invention relates generally to the field of online or virtual meetings, and more particularly to locally mirroring the actions of a presenter to devices of meeting participant.

Online or virtual meetings are shared experiences among users that typically include a stream of audio and video as part of the presentation. In many types of meetings, one or more presenters have control of the meeting and stream video capture of a desktop or other computing environment to participants in the meeting. Typically, participants can view the presenter's actions via the captured video stream that is broadcasted to participants in the meeting.

### SUMMARY

Embodiments of the present invention provide a method, computer system, and computer program product to minimize data transfer in an online meeting. A processor initiates an online meeting between at least one broadcaster and at least one viewer. A processor captures actions performed by the at least one broadcaster during the online meeting. A processor converts at least one action performed by the broadcaster to a uniform resource identifier (URI). A processor sends the captured actions including the URI to the at least one viewer, where the captured actions including the URI replicate locally the at least one broadcaster's captured actions on a device associated with the viewer.

### BRIEF DESCRIPTION OF THE SEVERAL VIEWS OF THE DRAWINGS

FIG. 1 depicts a block diagram of components of the computing device executing a broadcast program, a meeting coordinator and a viewing program, in accordance with an exemplary embodiment of the present invention

FIG. 2 is a functional block diagram illustrating a collaborative environment, in accordance with an exemplary embodiment of the present invention.

FIG. 3 illustrates operational processes of a broadcast program, on a computing device within the environment of FIG. 1, in accordance with an exemplary embodiment of the present invention.

FIG. 4 illustrates operational processes of a meeting coordinator, on a computing device within the environment of FIG. 1, in accordance with an exemplary embodiment of the present invention.

FIG. 5 illustrates operational processes of a viewer program, on a computing device within the environment of FIG. 1, in accordance with an exemplary embodiment of the present invention.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as broadcast program 212, meeting coordinator 222 and viewing program 232, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and eache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

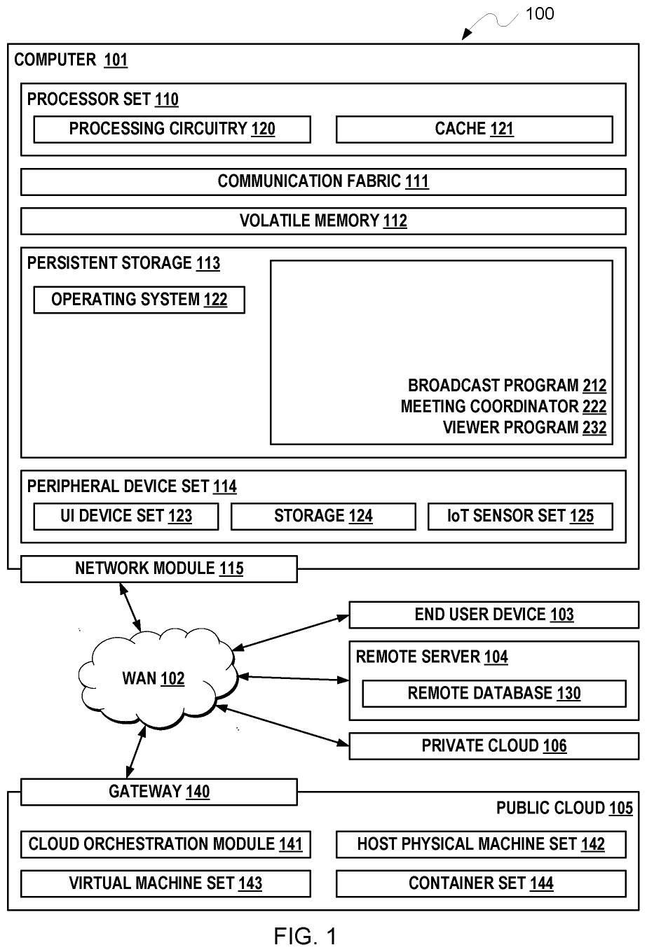

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the eache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as eache 121 and the other storage media discussed below. The program instructions, and associated data, are accessed by processor set 110 to control and direct performance of the inventive methods. In computing environment 100, at least some of the instructions for performing the inventive methods (i.e., broadcast program 212, meeting coordinator 222 and viewing program 232) may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

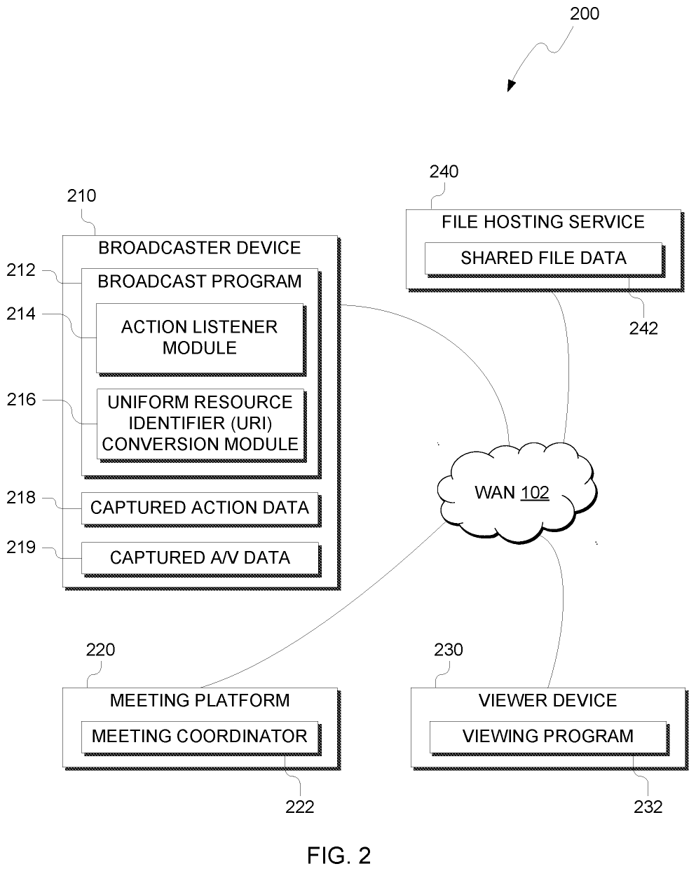

FIG. 2 is a functional block diagram illustrating collaborative environment, generally designated 200, in accordance with one embodiment of the present invention. Collaborative environment 200 includes broadcaster device 210, meeting platform 220, viewer device 230 and file hosting service 240 connected over WAN 102. Broadcaster device 210 includes broadcaster program 212, action listener module 214, uniform resource identifier (URI) conversion module 216, captured action data 218 and captured video data 219. Meeting platform 220 includes meeting coordinator 222. Viewer device 230 includes viewing program 232. File hosting service 240 includes shared file data 242.

In various embodiments of the present invention, broadcaster device 210, meeting platform 220, viewer device 230 and file hosting service 240 are each a computing device that can be a standalone device, a server, a laptop computer, a tablet computer, a netbook computer, a personal computer (PC), or a desktop computer. In another embodiment, broadcaster device 210, meeting platform 220, viewer device 230 and file hosting service 240, collectively or individually, represent a computing system utilizing clustered computers and components to act as a single pool of seamless resources. In general, broadcaster device 210, mecting platform 220, viewer device 230 and file hosting service 240 can be any computing device or a combination of devices with access to captured action data 218, captured video data 219, and shared file data 242; and is capable of executing broadcaster program 212, action listener module 214, uniform resource identifier (URI) conversion module 216, meeting coordinator 222 and viewing program 232. Broadcaster device 210, meeting platform 220, viewer device 230 and file hosting service 240 may include internal and external hardware components, as depicted and described in further detail with respect to FIG. 1.

In this exemplary embodiment, broadcaster program 212, action listener module 214, uniform resource identifier (URI) conversion module 216, captured action data 218 and captured video data 219 are stored on broadcaster device 210; meeting coordinator 222 is stored on meeting platform 220; viewing program 232 on viewer device 230; and shared file data 242 is stored on file hosting service 240. However, in other embodiments, broadcaster program 212, action listener module 214, uniform resource identifier (URI) conversion module 216, meeting coordinator 222, viewing program 232 captured action data 218, captured video data 219, and shared file data 242 may be stored externally and accessed through a communication network, such as WAN 102.

In various embodiments, various users utilize meeting platform 220 to collaborate in an online meeting. At least one user is a broadcaster utilizing broadcaster device 210 to transmit captured computing environment information from broadcaster device 212 to viewers and other participants of the meeting. Prior solutions in online meetings have traditionally captured video of the computing environment of broadcaster device 212 to disseminate to viewers, however video and images require large amounts of data. Other solutions capture mouse movements and other operating system level interactions of the broadcaster to save on bandwidth, however these solutions do not capture many other application specific interactions that a user can make when utilizing an operating system or other computing environment.

Embodiments of the present invention provide for a method, computer system and computer program product that captures a broadcaster's actions. By listening for a variety of actions, some of which may be application specific, embodiments of the present invention capture the observed actions of the broadcaster as uniform resource identifiers (URIs) which can capture actions such as opening files in applications as well as actions with certain applications, such as a web browser. Embodiments of the present invention improve over prior solutions by capturing more than just images, video or even mouse movements. By codifying actions of a broadcaster, embodiments of the present invention save on bandwidth by relieving the need to transmit video capture as required by most collaboration solutions. Furthermore, by encoding appropriate actions as URIs, embodiments of the present invention can provide viewer with local replication of the viewers action using native applications on the viewer's device.

In various embodiments, broadcast program 212 receives input from a user (i.e., broadcaster) to start an online meeting via meeting platform 220. Meeting platform 220 can be any online meeting, video conferencing, or collaborative service that permits the broadcaster using broadcaster device 210 to initiate a meeting, call or any other type of communication with a viewer using viewer device 230. While FIG. 1 depicts only a single viewer device 230, it will be understood by one of ordinary skill in the art that multiple viewers, as well as broadcasters, may join the meeting via their respective devices (not shown) without deviating from the invention. Furthermore, in some scenarios, viewers may also be broadcasters. In such scenarios, control and data flow of the viewing program 232 becomes that of broadcast program 212, as discussed herein.

In various embodiments, when broadcast program 212 starts the meeting, broadcast program 212 begins capturing audio of the broadcaster as well as video data of the computing environment (e.g., desktop capture) of the broadcaster device 210 while the meeting is ongoing as captured audio/video (A/V) data 219. In some scenarios, captured A/V data 219 may also include a camera capture of the broadcaster while conducting the meeting. Broadcast program 212 sends the captured A/V data 219 to meeting coordinator 222. Prior solutions would immediately send captured A/V data 219 to viewer program 232. However, in many scenarios, embodiments of the present invention only send the audio portion of the captured broadcast to viewer program 232. As will be discussed herein, action listen module 214 monitors the various actions a broadcaster makes within the computing environment of broadcaster device 210, such as opening a file or clicking through links in a web browser. In various embodiments, meeting coordinator 222 receives these actions as captured action data 218 and instead of sending video of the broadcaster actions, sends these actions to viewing program 232 to replicate locally on viewer device 230. Embodiments of the present invention recognize that disseminating captured A/V data 219 can be bandwidth and processor intensive for all parties for operations like encoding (broadcaster), disseminating (coordinator) and decoding (viewer) video data. By replacing video data with captured action data 218, embodiments of the present invention can save on bandwidth costs while still replicating the actions of the broadcaster on the viewer device 230, thereby allowing viewers to still witness the action of the broadcaster without the need for transporting video data.

In various embodiments, while a meeting is being captured, action listen module 214 monitors various action taken by the broadcaster within a computing environment or operating system of broadcaster device 210. As the broadcaster performs such actions, broadcaster program 212 stores and sends the captured actions as captured action data 218. For example, action listener module 214 listens for and captures the broadcasters mouse movements within the computing environment of broadcaster device 210. Broadcast program 212 captures these movements as captured action data 218. Then, as the meeting is ongoing, broadcast program 212 sends the actions in captured action data 218 to meeting coordinator 222. Meeting coordinator 222 then sends each captured action to viewers via viewer program 232. Viewer program 232 in turn replicates the captured mouse movements in the viewer computing environment for viewer device 230.

In various scenarios, another action that is captured by action listener module 214 is any file opening actions taken by the broadcaster. Using the example above regarding captured mouse movements, action listener module 214 monitors and records a broadcaster opening a file on broadcaster device 210. In this example, the file is remotely hosted on file hosting service 240 as shared file data 242. When the broadcaster opens the file locally to discuss during the meeting, action listener module 214 identifies the action and the converts the action to a uniform resource identifier or URI. URIs are identifiers that can codify the location of both logical and physical resources.

URIs follow a general syntax which provides flexibility in codify and identifying a variety of resources. The syntax for URIs typically consists of five parts (i.e., scheme, authority, path, query and fragment) and are formatted in a string of characters using the following arrangement: “scheme:// authority path ? query #fragment”. The scheme designates the protocol or type of resource being accessed. Example official schemes include “mailto” for email resources, “file” for local files, and “http” or “https” for web-based resource, which use uniform resource locators (URLs) which are a subset of URIs. Authority is the host or domain of the resource (e.g., website.com). If the URI is local or relative to the user domain, then the authority may be omitted (e.g., “file:” scheme may omit a host/domain if referring to a location on the user's computer). Path is the file path to access the resource for the given authority (e.g., “UserSpace/downloads/”). The query represents any action to be perform on or by the resource. For webpages and resources that accept user queries or other inputs, such as a search engine, this portion of the URI represents the user provided portion of the request. Fragment represents any additional files or resources that are to be accessed in the request.

Based on the above, URIs can be used to represent a larger variety of resources, both online and local, as well as physical and logical. As previously stated, as large variety of schemes exist to support a variety of standards and platforms. Furthermore, application developers can create URI schemes to support various operations and functions of the applications and platforms they support. For example, INTERNATIONAL BUSINESS MACHINES CORPORATION® created an official URI under the Internet Assigned Numbers Authority (IANA) to support various queries and requests for the company's LOTUS NOTES® platform. Numerous unofficial URIs are maintained and supported as well, such as a variety of URIs for MICROSOFT OFFICE® products.

Embodiments of the present invention recognize that by converting actions performed in supported applications, URIs can be generated to represent various complex actions a broadcaster may make during a meeting. Actions such as opening a file could be conveyed via a URI pointing viewers to the resource. Instead of displaying captured A/V data 219, meeting coordinator 222 can send URIs via captured action data 218 to replicate the presentation locally on the viewer device 230. As such, the captured URIs in captured action data 218 can greatly cut down on bandwidth and latency associated with transporting video (i.e., captured A/V data 219) while still giving viewers a “view” of the meeting that is locally recreated using applications and programs installed on viewer device 230.

In some embodiments, captured A/V data 219 also includes actions that cannot be represented with URIs, such as mouse movements, that a broadcaster may make during a meeting. Action listener module 214 records operating system events and inputs such as, but not limited to, mouse movements, mouse clicks, scroll wheel, touch inputs, keyboard strokes and other user interactions with broadcaster device 210. By doing so, meeting coordinator 222 can send such actions to viewer program 232 to replicate the various inputs the broadcaster performed locally so that the viewer can observe actions locally on viewer device 230, without displaying the video of said inputs from the broadcaster during the meeting.

In various scenarios, a broadcaster may open a file to demonstrate during the meeting. For example, the broadcaster may open a file as shared file data 242 that is stored on file hosting service 240. Many cloud storage providers and file hosting services maintain a URI scheme to access files. In various embodiments, when action listener module 214 observes a broadcaster opening a file that is shared on file hosting service 240, then URI conversion module 216 generates a compliant URI that references the shared file data 242. In some scenarios, a user may open a locally stored file that is replicated in shared file data 242 of file hosting service 240. When action listener module 214 detects a local file being opened, URI conversion module 216 determines if the local path is part of a replication of shared file data 242 of file hosting service 240. For example, many services store files in predetermined locations of a filesystem. If a file is opened locally whose path includes these known locations, URI conversion module 216 retrieves a URI for the file through an application programming interface (API) call to the file hosting service 240, which returns the URI for the shared file data 242.

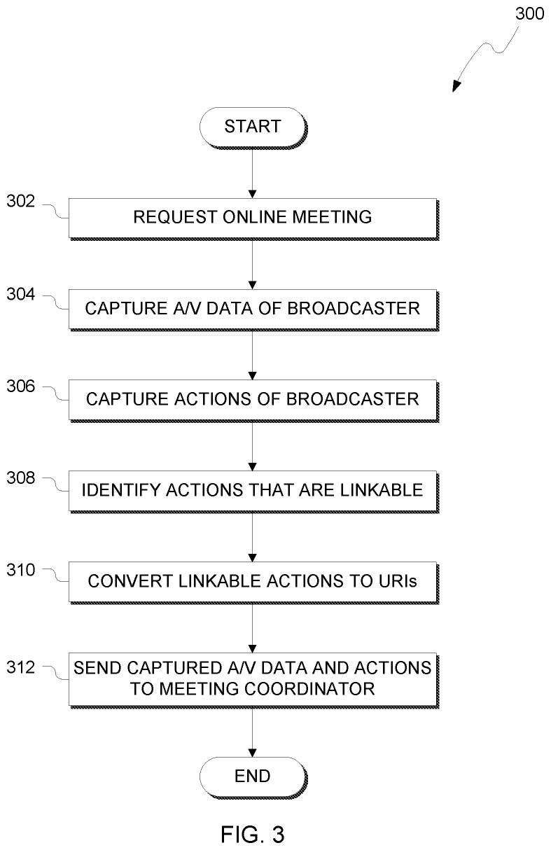

FIG. 3 illustrates operational processes, generally designated as 300, of broadcast program 212. In process 302, the broadcaster requests the start to an online meeting. In some scenarios, the broadcaster may invite viewers by sending a link or other information to the intended viewers. In other scenarios, the online meeting is open to the public and any user that joins is a viewer. In process 304, broadcast program 212 captures audio and video data of the desktop environment and the broadcaster's speech, if provided. As the broadcaster performs actions within the desktop environment, broadcast program 212 captures video of the broadcaster performance. While embodiments of the present invention primarily rely on captured action data to lower bandwidth costs of the meeting, captured A/V data 219 is stored as a fallback in case portions of the meeting can not be replicated locally on viewer device 230.

In process 306, broadcast program 212 captures actions of the broadcaster. Captured actions include but are not limited to, opening files, using a web browser, mouse movements, keyboard inputs and the like. As the broadcaster interacts with broadcaster device 210, action listener module 214 monitors and records each action taken by the broadcaster as captured action data 218. In process 308, broadcast program 212 identifies any actions in captured action data 218 that can be converted to URI link. URI conversion module 216 includes a list of known actions and programs that can be converted to URI links. For example, URI conversion module 216 includes a list of known file hosting services to identify when the broadcaster opens a file that is accessible as shared file data 242 to viewers (i.e., viewer device 230).

In process 310, broadcast program 212 converts linkable actions to URIs. URI conversion module 216 includes a list of known URI schemes associated with the list of known actions. When a broadcaster performs a known action as identified in process 308, URI conversion module 216 retrieves the URI scheme for the type of action and converts the recorded action to a URI. In process 312, broadcast program 212 sends both captured a/v data 219 and captured action data 218 (which includes at least one action converted to a URI) to meeting coordinator 222 to broadcast and conduct the online meeting among viewers.

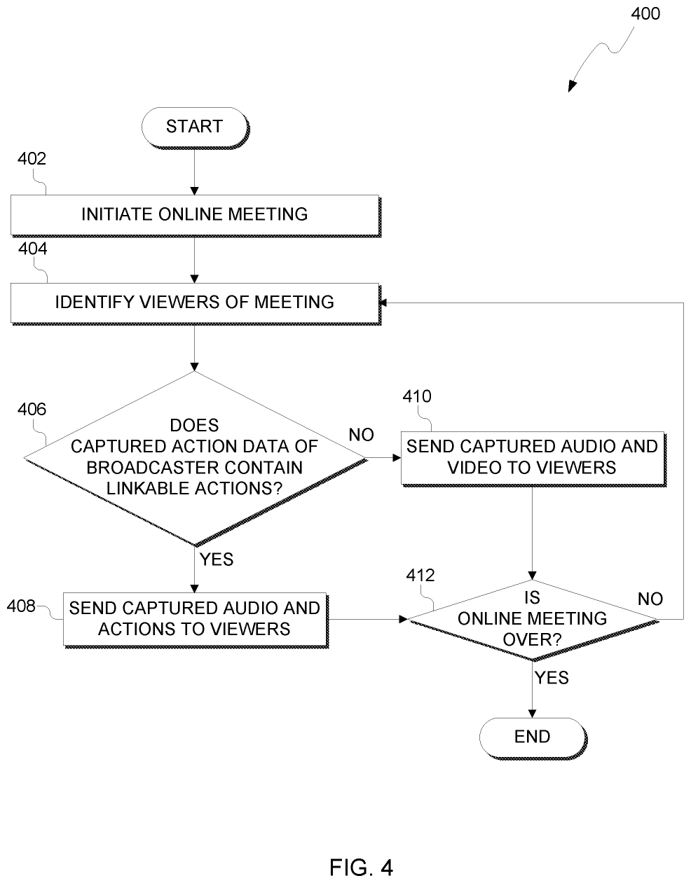

FIG. 4 illustrates operational processes, generally designated as 400, of meeting coordinator 222. In process 402, meeting coordinator 222 initiates an online meeting. Broadcaster program 212 receives input from the broadcaster to request an online meeting. In response, meeting coordinator 222 creates an online meeting space for viewers to view the meeting. In process 404, meeting coordinator 222 identities viewers of the meeting. As the broadcaster starts the meeting, viewers may connect and leave. In process 404, meeting coordinator identifies the current viewers of the meeting.

In decision process 406, meeting coordinator 222 evaluates captured action data 218 sent from broadcaster program 212. If the captured action data being sent to viewers contains linkable actions (YES Branch of decision process 406), then meeting coordinator 222 sends only audio of the broadcaster and replaces the video portion by locally opening the linkable actions (process 408). Linkable actions, as discussed herein, are captured actions that can be linked or otherwise accessed by a URI. In process 408, by only sending audio of the broadcaster and locally replicating the actions of the broadcaster, embodiments of the present invention are able to remove the need for sending video to viewers while still replicating the actions of the broadcaster for the viewer to observe.

If the actions of the broadcaster are not linkable (i.e., cannot be converted to a URI), then meeting coordinator 222 sends captured A/V data 219 to viewers of the meeting. In scenarios where actions cannot be replicated locally for viewers, meeting coordinator 222 sends captured A/V data 219, including both audio and video of the broadcaster, to viewers such that the viewers can observe the actions of the broadcaster. In decision process 412, meeting coordinator 222 checks to see if the broadcaster has ended the meeting. If the meeting is still ongoing (NO branch of decision process 412), then meeting coordinator 222 returns to process 404, to monitor current active viewers. As such, as the meeting progresses, meeting coordinator can switch between process 408 and 410, sending linkable actions when possible and falling back to video when actions of the broadcaster cannot be converted to a URI. Once the meeting ends (YES branch of decision process 412), then meeting coordinator 222 ends the meeting and stops sending captured action data 218 and captured A/V data 219 to viewers.

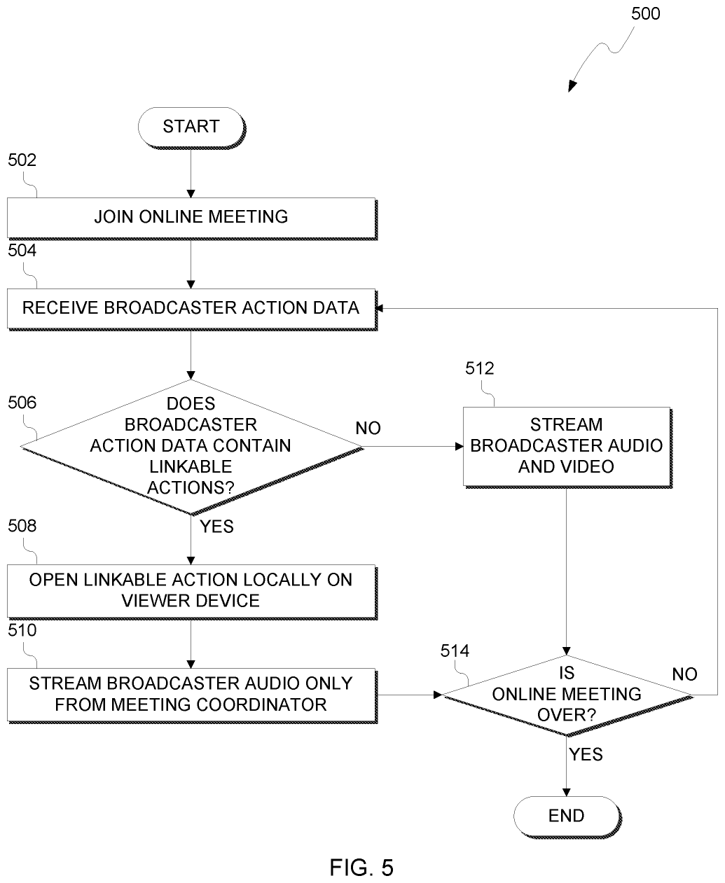

FIG. 5 illustrates operational processes, generally designated 500, of viewer program 232. In process 502, a viewer joins the online meeting hosted by the broadcaster. In process 504, viewer program 232 receives captured action data 218 from meeting coordinator 222. In decision process 506, if the received captured action data 218 contains linkable actions (YES branch of decision process 506) then viewer program 232 opens the linkable action locally (process 508). As discussed herein, when portions of an online meeting have linkable actions, viewer program 232 only streams audio from meeting coordinator 222 (process 510). Since the visual aspect of the meeting can be replicated using linkable actions, viewer program 232 does not need to receive bandwidth intensive video data. However, if the actions in captured action data 218 are not linkable (NO branch of decision process 506), then viewer program 232 reverts to streaming both audio and video of the broadcaster's capture (process 512). If the meeting is ongoing and not over (NO branch of decision process 514), then viewer program 232 re-evaluates broadcaster action data as the data is received from meeting coordinator 222. If the current captured action data 218 of the broadcaster includes linkable actions, then viewer program 232 switches to an audio only stream and replicates actions locally on viewer device 230 (i.e., processes 508 and 510). If the current captured action data 218 does not include linkable actions, then viewer program 232 switches to streaming both audio and video (i.e., process 512)

Some embodiments of the present invention are directed to a computer-implemented method including: initiating an online meeting between at least one broadcaster and at least one viewer, capturing actions performed by the at least one broadcaster during the online meeting, converting at least one action performed by the broadcaster to a uniform resource identifier (URI), and sending the captured actions including the URI to the at least one viewer, wherein the captured actions including the URI replicate locally the at least one broadcaster's captured actions on a device associated with the viewer. Advantageously, embodiments of the present invention provide advantages over prior solutions by sending less-bandwidth intensive converted actions and replicating them locally, instead of just transporting and delivering video, as many prior solutions perform.

One aspect of the computer-implemented method disclosed herein may include where the converted at least one action is associated with access to a shared file. Another aspect of the computer-implemented method disclosed herein may include where the shared file is opened on the device associated with the viewer in response to receiving the converted at least one action. Another aspect of the computer-implemented method disclosed herein may include where an audio stream of the online meeting is provided without a video stream of the online meeting. Advantageously, if a shared online resource can be identified in a meeting, viewer devices can automatically open the file without the need to download video of the online meeting.

Yet another aspect of the computer-implemented method disclosed herein may include sending a video capture of the online meeting to the at least one viewer for the portion of the online meeting where captured actions could not be converted, in response to a portion of the captured actions being not linkable. Advantageously, when actions cannot be converted to URIs, users can still view the meeting via a video broadcast.

Yet another aspect of the computer-implemented method disclosed herein may include where the URI is generated based, in part, on an application in which the captured actions were made by the at least one broadcaster. Advantageously, URIs provide a framework to not only identify a resource but also codify the application type used to access the resource, thereby making local replication of the action for viewers possible.

Yet another aspect of the computer-implemented method disclosed herein may include sending a video capture of the online meeting to the at least one viewer for a portion of the online meeting where the shared file is accessed by the at least one broadcaster, in response to the at least one viewer not being able to access the shared file via the URI. Advantageously, if a viewer is unable or unauthorized to access a shared file, embodiments of the present invention provide a fallback video feed for the viewer.

Some embodiments of the present invention are directed toward a computer program product comprising a computer-readable storage medium having a set of instructions stored therein which, when executed by a processor, causes the processor to perform a method including: initiating an online meeting between at least one broadcaster and at least one viewer, capturing actions performed by the at least one broadcaster during the online meeting, converting at least one action performed by the broadcaster to a uniform resource identifier (URI), and sending the captured actions including the URI to the at least one viewer, wherein the captured actions including the URI replicate locally the at least one broadcaster's captured actions on a device associated with the viewer. Advantageously, embodiments of the present invention provide advantages over prior solutions by sending less-bandwidth intensive converted actions and replicating them locally, instead of just transporting and delivering video, as many prior solutions perform.

One aspect of the computer program product disclosed herein may include where the converted at least one action is associated with access to a shared file. Another aspect of the computer program product disclosed herein may include where the shared file is opened on the device associated with the viewer in response to receiving the converted at least one action. Another aspect of the computer program product disclosed herein may include where an audio stream of the online meeting is provided without a video stream of the online meeting. Advantageously, if a shared online resource can be identified in a meeting, viewer devices can automatically open the file without the need to download video of the online meeting.

Yet another aspect of the computer program product disclosed herein may include sending a video capture of the online meeting to the at least one viewer for the portion of the online meeting where captured actions could not be converted, in response to a portion of the captured actions being not linkable. Advantageously, when actions cannot be converted to URIs, users can still view the meeting via a video broadcast.

Yet another aspect of the computer program product disclosed herein may include where the URI is generated based, in part, on an application in which the captured actions were made by the at least one broadcaster. Advantageously, URIs provide a framework to not only identify a resource but also codify the application type used to access the resource, thereby making local replication of the action for viewers possible.

Yet another aspect of the computer program product disclosed herein may include sending a video capture of the online meeting to the at least one viewer for a portion of the online meeting where the shared file is accessed by the at least one broadcaster, in response to the at least one viewer not being able to access the shared file via the URI. Advantageously, if a viewer is unable or unauthorized to access a shared file, embodiments of the present invention provide a fallback video feed for the viewer.

Some embodiments of the present invention are directed toward a computer system including: a processor set; and a computer readable storage medium. The processor set is structured, located, connected, and/or programmed to run program instructions stored on the computer readable storage medium. The program instructions, when executed by the processor set, cause the processor set to perform a method including initiating an online meeting between at least one broadcaster and at least one viewer, capturing actions performed by the at least one broadcaster during the online meeting, converting at least one action performed by the broadcaster to a uniform resource identifier (URI), and sending the captured actions including the URI to the at least one viewer, wherein the captured actions including the URI replicate locally the at least one broadcaster's captured actions on a device associated with the viewer. Advantageously, embodiments of the present invention provide advantages over prior solutions by sending less-bandwidth intensive converted actions and replicating them locally, instead of just transporting and delivering video, as many prior solutions perform.

One aspect of the computer system product disclosed herein may include where the converted at least one action is associated with access to a shared file. Another aspect of the computer program product disclosed herein may include where the shared file is opened on the device associated with the viewer in response to receiving the converted at least one action. Another aspect of the computer program product disclosed herein may include where an audio stream of the online meeting is provided without a video stream of the online meeting. Advantageously, if a shared online resource can be identified in a meeting, viewer devices can automatically open the file without the need to download video of the online meeting.

Yet another aspect of the computer system disclosed herein may include sending a video capture of the online meeting to the at least one viewer for the portion of the online meeting where captured actions could not be converted, in response to a portion of the captured actions being not linkable. Advantageously, when actions cannot be converted to URIs, users can still view the meeting via a video broadcast.

Yet another aspect of the computer system disclosed herein may include where the URI is generated based, in part, on an application in which the captured actions were made by the at least one broadcaster. Advantageously, URIs provide a framework to not only identify a resource but also codify the application type used to access the resource, thereby making local replication of the action for viewers possible.

Yet another aspect of the computer system disclosed herein may include sending a video capture of the online meeting to the at least one viewer for a portion of the online meeting where the shared file is accessed by the at least one broadcaster, in response to the at least one viewer not being able to access the shared file via the URI. Advantageously, if a viewer is unable or unauthorized to access a shared file, embodiments of the present invention provide a fallback video feed for the viewer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

What is claimed is:

1. A computer-implemented method comprising:
initiating an online meeting between at least one broadcaster and at least one viewer;
capturing actions performed by the at least one broadcaster during the online meeting;
converting at least one action performed by the broadcaster to a uniform resource identifier (URI); and
sending the captured actions including the URI to the at least one viewer, wherein the captured actions including the URI replicate locally the at least one broadcaster's captured actions on a device associated with the viewer.

2. The method of claim 1, wherein the URI is associated with an action of accessing a shared file.

3. The method of claim 2, wherein the shared file is opened on the device associated with the viewer in response to receiving the URI.

4. The method of claim 3, wherein an audio stream of the online meeting is provided without a video stream of the online meeting.

5. The method of claim 3, the method further comprising:
in response to a portion of the captured actions being not linkable, sending a video capture of the online meeting to the at least one viewer for the portion of the online meeting where captured actions could not be converted.

6. The method of claim 1, wherein the URI is generated based, in part, on an application in which the captured actions were made by the at least one broadcaster.

7. The method of claim 2, the method further comprising:
in response to the at least one viewer not being able to access the shared file via the URI, sending a video capture of the online meeting to the at least one viewer for a portion of the online meeting where the shared file is accessed by the at least one broadcaster.

8. A computer program product comprising:
one or more computer-readable storage media and program instructions stored on the one or more computer-readable storage media, the program instructions comprising:
program instructions to initiate an online meeting between at least one broadcaster and at least one viewer;
program instructions to capture actions performed by the at least one broadcaster during the online meeting;
program instructions to convert at least one action performed by the broadcaster to a uniform resource identifier (URI); and
program instructions to send the captured actions including the URI to the at least one viewer, wherein the captured actions including the URI replicate locally the at least one broadcaster's captured actions on a device associated with the viewer.

9. The computer program product of claim 8, wherein the converted at least one action is associated with access to a shared file.

10. The computer program product of claim 9, wherein the shared file is opened on the device associated with the viewer in response to receiving the converted at least one action.

11. The computer program product of claim 10, wherein an audio stream of the online meeting is provided without a video stream of the online meeting.

12. The computer program product of claim 10, the program instructions further comprising:
program instructions, in response to a portion of the captured actions being not linkable, to send a video capture of the online meeting to the at least one viewer for the portion of the online meeting where captured actions could not be converted.

13. The computer program product of claim 8, wherein the URI is generated based, in part, on an application in which the captured actions were made by the at least one broadcaster.

14. The computer program product of claim 9, the program instructions further comprising:
program instructions, in response to the at least one viewer not being able to access the shared file via the URI, to send a video capture of the online meeting to the at least one viewer for a portion of the online meeting where the shared file is accessed by the at least one broadcaster.

15. A computer system comprising:
one or more computer processors;
one or more computer readable storage media; and
program instructions stored on the computer readable storage media for execution by at least one of the one or more processors, the program instructions comprising:
program instructions to initiate an online meeting between at least one broadcaster and at least one viewer;
program instructions to capture actions performed by the at least one broadcaster during the online meeting;
program instructions to convert at least one action performed by the broadcaster to a uniform resource identifier (URI); and
program instructions to send the captured actions including the URI to the at least one viewer, wherein the captured actions including the URI replicate locally the at least one broadcaster's captured actions on a device associated with the viewer.

16. The computer system of claim 15, wherein the converted at least one action is associated with access to a shared file.

17. The computer system of claim 16, wherein the shared file is opened on the device associated with the viewer in response to receiving the converted at least one action.

18. The computer system of claim 17, wherein an audio stream of the online meeting is provided without a video stream of the online meeting.

19. The computer system of claim 17, the program instructions further comprising:
program instructions, in response to a portion of the captured actions being not linkable, to send a video capture of the online meeting to the at least one viewer for the portion of the online meeting where captured actions could not be converted.

20. The computer system of claim 15, wherein the URI is generated based, in part, on an application in which the captured actions were made by the at least one broadcaster.
